(19) United States
(12) Patent Application Publication
(10) Pub. No.: US 2026/0110548 A1
(43) Pub. Date: Apr. 23, 2026

(54) ENVIRONMENT MAP GENERATION APPARATUS, ENVIRONMENT MAP GENERATION METHOD AND PROGRAM

(71) Applicant: NTT, Inc., Tokyo (JP)

(72) Inventor: Seiji YOSHIDA, Tokyo (JP)

(73) Assignee: NTT, Inc., Tokyo (JP)

(21) Appl. No.: 19/114,278

(22) PCT Filed: Sep. 27, 2022
(86) PCT No.: PCT/JP2022/035963

§ 371 Date: Mar. 21, 2025

(51) Int. Cl. G01C 21/00

(52) U.S. Cl. CPC G01C 21/3848

(57) ABSTRACT

An environment map production device includes: a calculation unit that calculates an evaluation value of validity of a positioning solution based on data obtained by measurement by a vehicle traveling in a certain area in a plurality of time zones using GNSS for each of a plurality of segments that divides the area; and a sort out unit that sorts out, on a basis of the evaluation value, the positioning solution used for production of an environment map and the positioning solution not used for production of an environment map, thereby efficiently producing an environment map and improving the quality of the environment map.

### TECHNICAL FIELD

The present invention relates to an environment map production device, an environment map production method, and a program.

### BACKGROUND ART

In autonomous traveling of an automatic traveling vehicle or an autonomous traveling robot, it is necessary to accurately estimate a position and a direction (orientation) of a traveling vehicle in real time for controlling the vehicle. Therefore, a method of estimating a self-position of a vehicle by scan matching data of spatial information of a surrounding environment obtained by LiDAR, a camera, Radar, or the like with an environment map using the environment map of the vicinity of a traveling area prepared in advance has been studied. As a typical scan matching algorithm, iterative closest point (ICP) and normal distributions transform (NDT) are known. The process of producing an environment map used in such applications is different from a general process of producing a two-dimensional (planar) map.

In the production of a two-dimensional map by an aerial photograph, an aerial photograph of a production target area is obtained by imaging, the photograph obtained by imaging is corrected to an orthographic image, and then a plurality of ground control points (GCP) is set in the production target area so that the absolute position of the image is calibrated. The positions of the ground control. points are measured by surveying in combination with an optical distance measuring means such as global navigation satellite systems (GNSS) or a total station. Such a method is effective for efficiently creating a two-dimensional map, but there is an issue that detailed information of a three-dimensional space near the ground that is used for self-position estimation of an autonomous traveling vehicle such as an automatic traveling vehicle or an autonomous traveling robot cannot be obtained.

As one of means for collecting spatial information from a road viewpoint used by an autonomous traveling vehicle, there is a measurement means using a dedicated vehicle-mounted surveying system called a mobile mapping system (MMS) The MMS includes a navigation sensor for measuring a vehicle position and an attribute sensor for collecting data of spatial information of the surrounding environment.

As the navigation sensor, a relative positioning means such as an inertial measurement unit (IMU) or odometry is included in addition to a GNSS signal receiver that measures an absolute position, and a vehicle position is measured by complex positioning by coupling processing of the data. As the attribute sensor, a device such as a laser scanner or a camera is included, and data is collected as a group of points having coordinate values called a point cloud. Colored point cloud data may be generated using image information of the camera.

As the environment map, a point cloud map itself or a vector map obtained by extracting feature data from the point cloud map and reducing the data capacity is used. The feature data includes a road side line, a road center line, a lane boundary line, a crosswalk, a road sign, a guardrail, and the like. The environment map data used by an autonomous traveling vehicle is required to have absolute positional accuracy of a level of several centimeters to several tens of centimeters, which enables lane determination of a road on which the autonomous traveling vehicle is traveling in self-position estimation of the vehicle.

### CITATION LIST

### Non Patent Literature

Non Patent Literature 1: Kiichiro Ishikawa, “Road Survey Using Mobile Mapping System”, Journal of the Japan Society of Precision Engineering Vol. 79, No. 5, 2013 p.397-400

### SUMMARY OF INVENTION

### Technical Problem

Regarding collection of data for an environment map by the MMS, measurement of a vehicle position in an area where GNSS positioning is difficult is an issue. In a reception environment called urban canyon in an urban area, since a satellite signal is blocked by a structure such as a building around a GNSS antenna, the number of visible satellites capable of receiving a satellite signal as a direct wave decreases, and a multipath signal generated by a satellite signal being reflected and diffracted by a structure is received, and accordingly, GNSS positioning accuracy deteriorates. Furthermore, in carrier phase positioning, a cycle slip in which continuous acquisition of the carrier wave phase is interrupted occurs.

A GNSS positioning solution in such an environment depends on a relative positional relationship between a satellite and a structure, and an error that is not a normal distribution of a zero center is caused, and thus it is difficult to accurately estimate a true value by an extended Kalman filter or the like. For this reason, in some cases, the measurement operation in the MMS fails, and rework occurs. Furthermore, in a case where a map is produced from point cloud data including an error in measured position data, there is an issue that time and effort are required for correction. In particular, in an urban canyon environment, an effective positioning solution cannot be obtained in a wide area in many cases and correction work is difficult, and thus correction using conventional optical surveying in combination may be required.

As described above, in production of an environment map by the MMS, there are issues of production costs and quality in a commercial area in an urban area where demand is high.

The present invention has been made in view of the above points, and an object thereof is to efficiently produce an environment map and improve the quality of the environment map.

### Solution to Problem

Therefore, in order to solve the above issues, an environment map production device includes: a calculation unit that calculates an evaluation value of validity of a positioning solution based on data obtained by measurement by a vehicle traveling in a certain area in a plurality of time zones using GNSS for each of a plurality of segments that divides the area; and a sort out unit that sorts out, on a basis of the evaluation value, the positioning solution used for production of an environment map and the positioning solution not used for production of an environment map.

### Advantageous Effects of Invention

An object is to efficiently produce an environment map and improve the quality of the environment map.

### BRIEF DESCRIPTION OF DRAWINGS

FIG. 1 is a diagram illustrating a configuration example of a map production system according to an embodiment of the present invention.

FIG. 2 is a diagram illustrating a configuration example of a data collection device 20 according to the embodiment of the present invention.

FIG. 3 is a diagram illustrating a configuration example of a self-position estimation device 30 according to the embodiment of the present invention.

FIG. 4 is a diagram illustrating a hardware configuration example of a map production/distribution server 10 according to the embodiment of the present invention.

FIG. 5 is a diagram illustrating a functional configuration example of the map production/distribution server 10 according to the embodiment of the present invention.

FIG. 6 is a diagram for describing a segment that divides production areas of an environment map.

FIG. 7 is a diagram for describing a method of evaluating a GNSS positioning suitability degree of a segment.

FIG. 8 is a diagram for describing a procedure of a validity test of a GNSS positioning solution.

FIG. 9 is a diagram for describing a test based on a height value of a GNSS positioning solution in a case where the GNSS positioning solution does not exist on a road.

FIG. 10 is a diagram for describing a test by consistency evaluation with data of an IMU 24, an odometry 26, and an EDR 25.

### DESCRIPTION OF EMBODIMENTS

In the present embodiment, a sufficient number of pieces of data are collected in a plurality of different time zones in an area for which an environment map is produced, and the data is sorted out by statistical processing based on a positioning result, thereby improving work efficiency of producing the environment map and improving the quality of the environment map. Furthermore, information regarding an expected value of GNSS positioning accuracy is distributed together with environment map data, thereby improving the reliability of self-position estimation operation of automatic traveling.

Hereinafter, an embodiment of the present invention will be described with reference to the drawings.

### Configuration

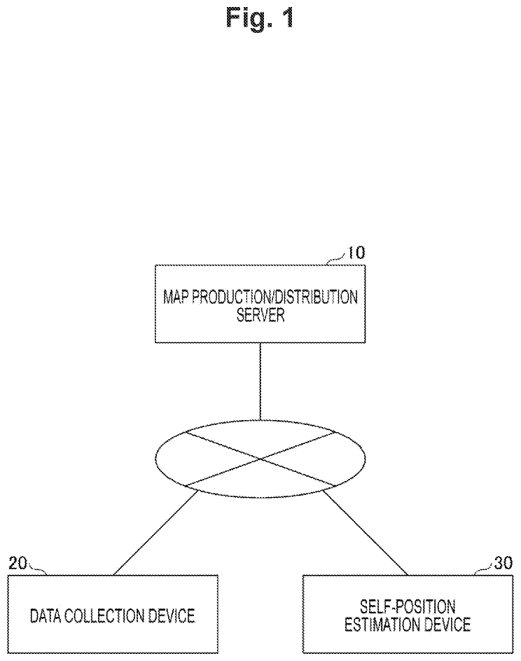

FIG. 1 is a diagram illustrating a configuration example of a map production system according to an embodiment of the present invention. In FIG. 1, the map production system includes one or more data collection devices 20, a map production/distribution server 10, and one or more self-position estimation devices 30. The data collection device 20 and the self-position estimation device 30 are connected to the map production/distribution server 10 via a communication network.

The data collection device 20 is a device for collecting data for environment map production, and is included in a measurement vehicle. The data collection device 20 uploads the collected data to the map production/distribution server 10.

The map production/distribution server 10 is one or more computers that generate map data of an environment map on the basis of the data uploaded from the data collection device 20. The map production/distribution server 10 distributes the generated map data to the self-position estimation device 30.

The self-position estimation device 30 is a device for performing self-position estimation using an environment map, and is included in an autonomous traveling vehicle such as an automatic traveling vehicle or an autonomous traveling robot.

Note that, as the environment map, a point cloud map itself or a vector map obtained by extracting feature data from the point cloud map and reducing the data capacity is used. The feature data includes a road side line, a road center line, a lane boundary line, a crosswalk, a road sign, a guardrail, and the like.

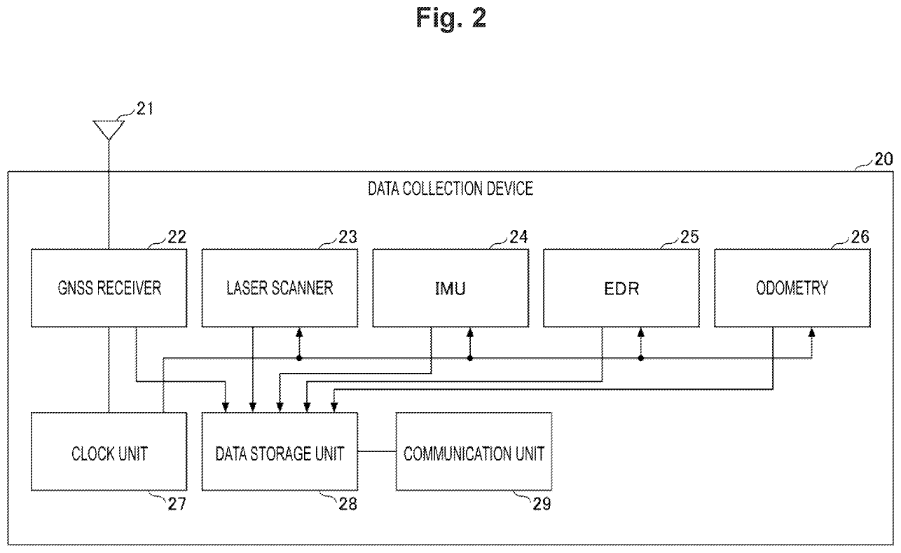

FIG. 2 is a diagram illustrating a configuration example of the data collection device 20 according to the embodiment of the present invention. In FIG. 2, the data collection device 20 includes a GNSS antenna 21, a GNSS receiver 22, a laser scanner 23, an inertial measurement unit (IMU) 24, an event data recorder (EDR) 25, an odometry 26, a clock unit 27, a data saving unit 28, a communication unit 29, and the like.

The GNSS receiver 22 outputs observation data of a GNSS satellite signal received by the GNSS antenna 21 and data related to a GNSS positioning state. The observation data of the GNSS satellite signal is data such as reception signal intensity, a pseudorange, a carrier phase, and a Doppler frequency of each satellite signal. The data related to the positioning state is data related to an error ellipse, a cycle slip, and the like.

The laser scanner 23 is a device that irradiates a surrounding object with a laser and measures a distance to the object with high accuracy, and is also called light detection and ranging (LiDAR).

The IMU 24 is a device including an acceleration sensor, a gyro sensor, a magnetic sensor, and the like.

The EDR 25 is a device that records a driving operation of the measurement vehicle such as an accelerator, a brake, and a steering wheel operation.

The odometry 26 is a device that calculates vehicle speed data from the rotation speed of the wheel of the measurement vehicle.

The clock unit 27 is synchronized with a GNSS satellite signal, and supplies highly accurate time information for measuring the measurement time of data in each device of the laser scanner 23, the IMU 24, the EDR 25, and the odometry 26.

The communication unit 29 is a communication interface used when data is updated to the map production/distribution server 10 via the communication network. In the communication unit 29, a vehicle to X (V2X) communication method such as a mobile communication method, a wireless local area network (LAN) method, or dedicated short-range communications (DRSC) is used.

The measured data may be uploaded in real time while the measurement vehicle is traveling, or may be collectively uploaded after data for a certain period of time is collected in the data saving unit 28. As an example, in a case where the GNSS observation data is transmitted in real time, a radio technical commission for maritime services (RTCM) format is used, and in a case where the GNSS observation data is transmitted collectively, a data format of a receiver independent exchange format (RINEX) format is used.

In addition to the laser scanner 23, a camera may be included in the data collection device 20 for detection and identification of feature data.

Data collection in the same area may be executed by performing measurement a plurality of times in different time zones by the same measurement vehicle, or may be executed by operating a plurality of measurement vehicles in different time zones.

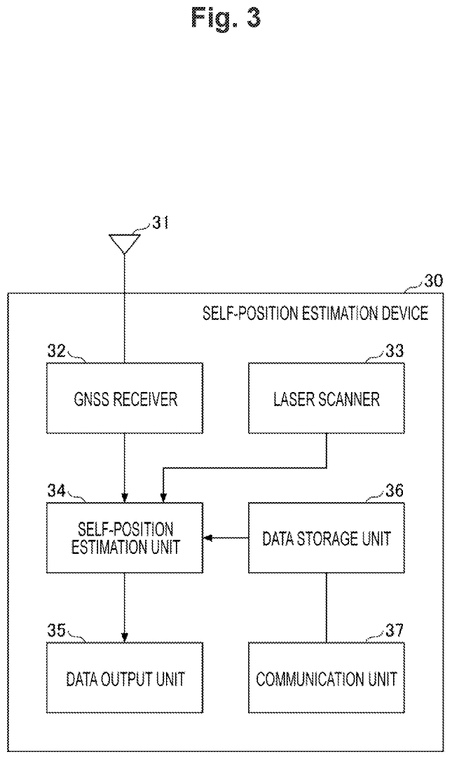

FIG. 3 is a diagram illustrating a configuration example of the self-position estimation device 30 according to the embodiment of the present invention. In FIG. 3, the self-position estimation device 30 includes a GNSS antenna 31, a GNSS receiver 32, a laser scanner 33, a self-position estimation unit 34, a data output unit 35, a data saving unit 36, a communication unit 37, and the like.

The GNSS receiver 32 performs positioning calculation using the GNSS satellite signal received by the GNSS antenna 31, and outputs an approximate position of the autonomous traveling vehicle in real time.

The self-position estimation unit 34 searches an environment map of the vicinity of the approximate position output from the GNSS receiver 32, and scan matches point cloud data of the surrounding environment acquired by the laser scanner 33 with the environment map, thereby estimating the self-position.

The data output unit 35 outputs coordinate data obtained as a result of self-position estimation in a format necessary for a control device of the autonomous traveling vehicle. The basic control of the autonomous traveling vehicle is to travel along a preset (planned) route. The control device controls the autonomous traveling vehicle so as to minimize a difference between the result of self-position estimation and the set (planned) route. The control device also performs obstacle detection, signal recognition, route setting, route resetting for obstacle avoidance, and the like.

The communication unit 37 is a communication interface used when environment map data and data including a GNSS positioning suitability degree to be described below are downloaded from the map production/distribution server 10. In the communication unit 37, a V2X communication method such as a mobile communication method, a wireless LAN method, or DRSC is used.

The data saving unit 36 saves the downloaded data such as the environment map.

Instead of the laser scanner 33 (or in addition to the laser scanner 33), a camera and a Radar may be included in the autonomous traveling vehicle. In this case, the self-position is estimated by scan matching point cloud data generated by output data of the camera and the Radar with the environment map. Furthermore, the self-position estimation device 30 may include a complex positioning means such as GNSS/IMU as a backup self-position estimation means in preparation for a failure of the laser scanner 33 or the self-position estimation unit 34.

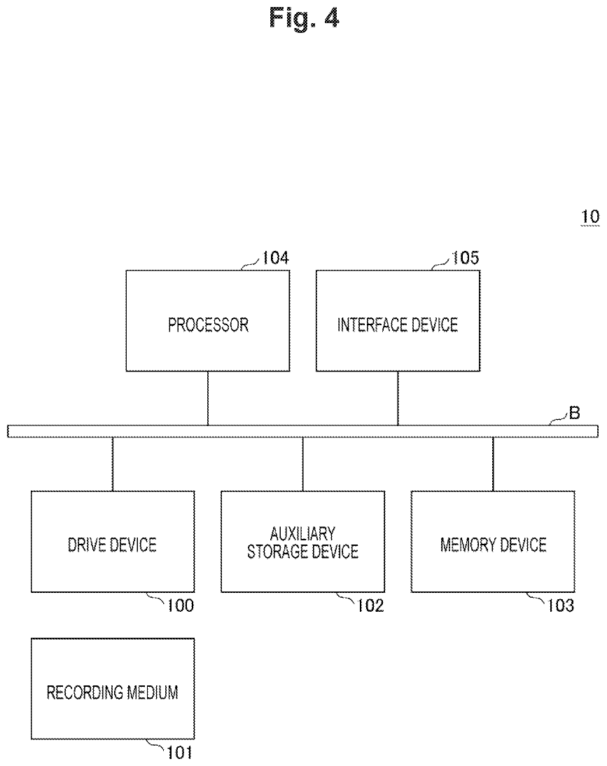

FIG. 4 is a diagram illustrating a hardware configuration example of the map production/distribution server 10 according to the embodiment of the present invention. The map production/distribution server 10 in FIG. 4 includes a drive device 100, an auxiliary storage device 102, a memory device 103, a processor 104, an interface device 105, and the like, which are connected to each other via a bus B.

A program for implementing processing in the map production/distribution server 10 is provided by a recording medium 101 such as a CD-ROM. When the recording medium 101 that stores the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores required files, data, and the like.

In a case where an instruction to start the program is made, the memory device 103 reads the program from the auxiliary storage device 102 and stores the program. The processor 104 is a CPU or a graphics processing unit (GPU), or a CPU and a GPU, and executes a function related to the map production/distribution server 10 according to the program stored in the memory device 103. The interface device 105 is used as an interface for connection to the network.

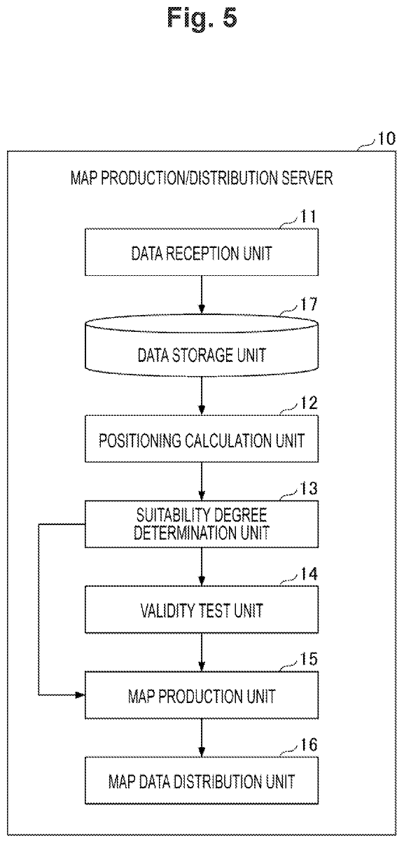

FIG. 5 is a diagram illustrating a functional configuration example of the map production/distribution server 10 according to the embodiment of the present invention. In FIG. 5, the map production/distribution server 10 includes a data reception unit 11, a positioning calculation unit 12, a suitability degree determination unit 13, a validity test unit 14, a map production unit 15, and a map data distribution unit 16. These units are implemented by processing executed by the processor 104 by one or more programs installed in the map production/distribution server 10. The map production/distribution server 10 also uses a data storage unit 17. The data storage unit 17 can be implemented by using, for example, the auxiliary storage device 102 or a storage device connectable to the map production/distribution server 10 via a network.

### Operation

The operation of the present embodiment includes (1) map production data collection process, (2) map production process, (3) map data distribution process, and (4) map data update process.

(1) map production data collection process is a process in which data necessary for map production is collected in a field by a measurement vehicle. (2) map production process is a process in which the map production/distribution server 10 produces an environment map. (3) map data distribution process is a process in which the map production/distribution server 10 distributes environment map data to an autonomous traveling vehicle. (4) map data update process is a process in which the environment map is updated.

Hereinafter, operation of each process will be described in detail.

### (1) Map Production Data Collection Process

The map production data collection process is a process in which data is collected by the data collection device 20 included in the measurement vehicle. The measurement vehicle repeatedly travels in a target area for which an environment map is produced, and collects data near the same measurement point at different times (timings). Therefore, the data collection device 20 may be included in a commercial vehicle such as a route bus, a shuttle bus, or a taxi that goes around in a specific area, other than the dedicated measurement vehicle. Furthermore, the number of vehicles that include the data collection device 20 that collects data of the same area is not limited to one but may be plural.

As an acquisition time of data by the laser scanner 23 (LiDAR), the IMU 24, the EDR 25, and the odometry 26, a time stamp based on a GNSS signal, that is, time information of the clock unit 27 synchronized with coordinated universal time (UTC) with high accuracy is recorded. Furthermore, the GNSS receiver 22 outputs observation data time-synchronized with a GNSS satellite signal and data related to a GNSS positioning state. An ID for identifying the measurement vehicle is assigned to the above measurement data.

The data collected in the data saving unit 28 may be uploaded to the map production/distribution server 10 in real time during traveling by the communication unit 29. Alternatively, the data may be once stored in the data saving unit 28, and the data may be collectively uploaded to the map production/distribution server 10 or output to another medium.

The data uploaded by the communication unit 29 is received by the data reception unit 11 of the map production/distribution server 10. The data reception unit 11 records the received data in the data storage unit 17.

### (2) Map Production Process

The map production process is a process in which the map production/distribution server 10 produces an environment map using the data collected by the measurement vehicle (data recorded in the data storage unit 17) after the measurement. In this process, first, the positioning calculation unit 12 executes positioning calculation processing (hereinafter, referred to as “GNSS positioning calculation”) using the collected observation data of the GNSS receiver 22. The GNSS positioning calculation is performed by the carrier phase (interference) positioning method. As the carrier phase positioning method, a real time kinematic (RTK)-GNSS positioning method using observation data of a reference station as correction information of observation space representation (OSR), a precise point positioning (PPP) method using correction information of state space representation (SSR) without using the observation data of the reference station, or a precise point positioning ambiguity resolution (PPP-AR) method is used.

As a GNSS positioning solution obtained as a result of the GNSS positioning calculation by the carrier phase positioning method in an ideal reception environment where there are no shielding objects such as structures or trees that block a satellite signal around the reception position, a value of an error (positioning accuracy) of the order of several centimeters with respect to a true value (reception position) is obtained. On the other hand, in a case where there is a shielding object around the reception position, the number of visible satellites is reduced due to the limitation of the sky area where a satellite signal can be received as a direct wave, and also the positioning accuracy is deteriorated due to reception of a multipath signal generated by a satellite signal being reflected and diffracted by the shielding object, and an error of several meters to several tens of meters or more in some cases occurs in the GNSS positioning solution. The error (noise) that occurs due to such a reception environment depends on the spatial position of the shielding object, and a normal distribution in which the true value (reception position) is set to zero (center) is not obtained. In other words, the error is not normal white noise. Therefore, it is difficult to estimate a true value in complex positioning in which a GNSS positioning solution and data of the IMU 24 and the odometry 26 are coupled using an extended Kalman filter or the like. That is, it is difficult to secure data of absolute position accuracy necessary for map production.

For the above reasons, not all the data collected in (1) map production data collection process is used for map production, but the data needs to be appropriately sorted out. In the map production process of the present embodiment, whether the GNSS positioning solution in a certain time epoch collected by the measurement vehicle in the map production data collection process is a valid solution close to the true value of the reception position that can be used for map production is determined by the following procedures of (A) GNSS positioning suitability degree determination and (B) validity test of GNSS positioning solution.

### (A) GNSS Positioning Suitability Degree Determination

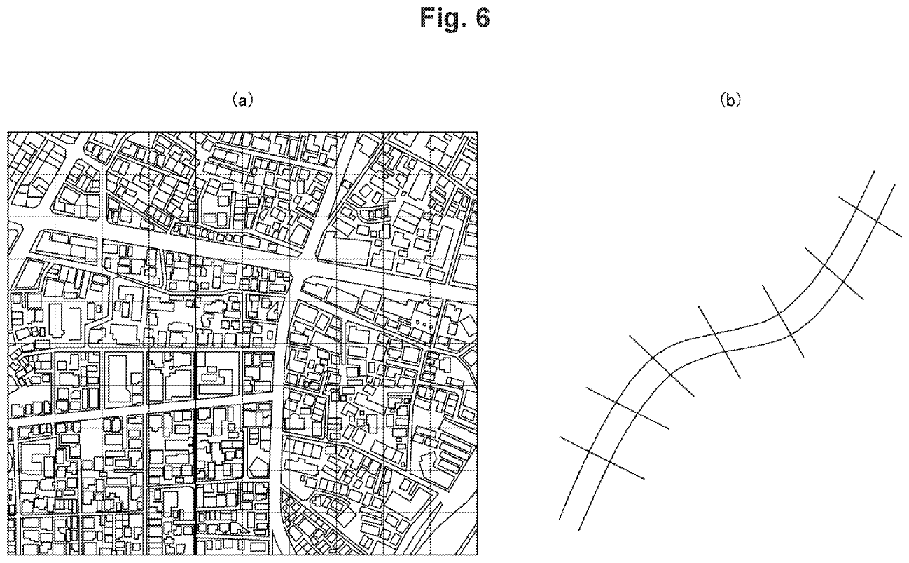

In determining the validity (that is, whether the solution is a valid solution close to the true value of the reception position) of GNSS positioning solutions obtained as a result of GNSS positioning calculation, it is not necessarily easy to determine the validity of individual GNSS positioning solutions. Therefore, as illustrated in FIG. 6, the suitability degree determination unit 13 divides a production area of an environment map into a plurality of segments, and ranks the suitability degree (degree of expectation of obtaining a valid solution: hereinafter, referred to as “GNSS positioning suitability degree”) of the GNSS positioning in each segment unit by statistical evaluation using a plurality of (a large number of) pieces of collected data in different time zones. The segments may divide the target area of the environment map into squares as illustrated in FIG. 6(a), or may divide the target area at regular intervals along a road on which an autonomous traveling vehicle travels in the target area as illustrated in FIG. 6(b).

Regarding a GNSS satellite signal, except for some of geosynchronous satellites, the satellite position viewed from the reception position goes around in the sky over time. For example, a global navigation system (GPS) satellite returns to substantially the same position in the sky in about 24 hours. In a reception environment where a structure exists around the reception position, a relative position relationship between a satellite position and the structure changes over time, and accordingly, a GNSS positioning solution at a certain reception position changes over time. Therefore, the magnitude of a positioning error (expected value of a statistical error) caused by the structure (reception environment) can be estimated by statistically evaluating many pieces of data measured in different time zones.

As a method of classifying each of the divided segments into classes based on a GNSS positioning suitability degree, the following methods including a method of evaluating a distribution of measurement data as described above are applied. Classification (ranking) of each of the segments is performed using any one of these methods or by combining a plurality of methods.

### (i) Evaluation by Plotting GNSS Positioning Solutions

The suitability degree determination unit 13 plots data of GNSS positioning solutions on a two-dimensional map. The data may be plotted with reference to a travel plan of the measurement vehicle from a vehicle ID and a measurement time of measurement data so that data at the time of traveling on the adjacent road is not mixed. The suitability degree determination unit 13 classifies a GNSS positioning suitability degree on the basis of the data plotted in this manner. Here, the purpose is not to evaluate plot positions of individual pieces of data but to evaluate a distribution state (degree of variation) of plot positions of the sum of a large number of pieces of data, and thus the absolute position accuracy of a two-dimensional map used for plotting does not matter.

Plots of GNSS positioning solutions are expected to be distributed within the range of the width of the road on which the measurement vehicle travels, except for the accuracy limit (error) unique to the GNSS positioning method, in an ideal reception environment without a shielding object around the reception position (antenna position). In the carrier phase positioning method, since a positioning error in an ideal reception environment is about several centimeters, it is expected that GNSS positioning solutions exist in the vicinity of a trajectory on which the vehicle actually passes (true values of reception positions).

On the other hand, in a non-ideal reception environment where a shielding object such as a building exists around a road, the GNSS positioning solutions are distributed being deviated from the true values. Since the error of a GNSS positioning solution changes with a change in the satellite position over time, the degree to which the GNSS positioning accuracy is affected by the reception environment in a certain segment, that is, the GNSS positioning suitability degree of the segment can be evaluated from the distribution state (magnitude of variation) of a large number of GNSS positioning solutions measured in different times,

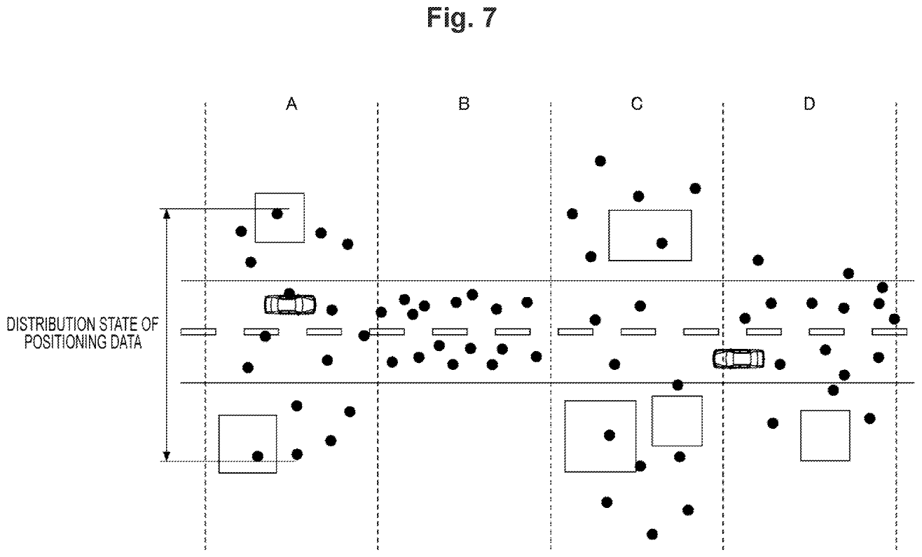

As an example of the evaluation method, the suitability degree determination unit 13 quantitatively evaluates the distribution state of the GNSS positioning solutions in the direction orthogonal to the road of the measurement area as illustrated in FIG. 7. This similarly applies to a case where a sidewalk is used as a measurement area. That is, in a case where the GNSS positioning solutions include errors, the errors are distributed in all directions in a two-dimensional plane, but since there is a fact that the vehicle that includes the data collection device 20 has traveled on a road (or a sidewalk) (information regarding true values), the errors can be estimated by measuring the distribution of positioning solutions in a direction orthogonal to the road.

Note that FIG. 7 corresponds to a case where the segments are divided as illustrated in FIG. 6(b), but even in a case where the segments are divided as illustrated in FIG. 6(a), the distribution state of the GNSS positioning solutions in a direction orthogonal to the road is quantitatively evaluated in the same manner. The quantitative evaluation value of the distribution state is, for example, a maximum deviation amount from a road center (center line) in a direction orthogonal to the road of the positioning solutions, a root mean square (RMS) value, or the like. In this case, it is evaluated that the GNSS positioning suitability degree is lower as the evaluation value is larger.

### (ii) Evaluation by Plotting Point Cloud Data

The suitability degree determination unit 13, using the GNSS positioning solutions and the point cloud data of structures obtained by the laser scanner 23, evaluates the distribution of measurement results (that is, distribution of positioning solutions) of measurement points (positions where the data collection device 20 has existed) in a case where point cloud data of the same structure is matched (superposed). Similarly to (i), the suitability degree determination unit 13 may plot data on a two-dimensional map with reference to a travel plan of the measurement vehicle from a vehicle ID and a measurement time of measurement data so that data at the time of traveling on the adjacent road is not mixed. If the accuracy of the GNSS positioning solutions is high, the distribution of the measurement points should approach the trajectory of the measurement vehicle, and it can be evaluated that the GNSS positioning suitability degree of the segment is lower as the degree of variation of the positions of the measurement points from the road width is larger. The suitability degree determination unit 13 evaluates the distribution of the measurement points using logic similar to that of the GNSS positioning solutions of (1), and classifies the positioning suitability degree of each of the segments.

(iii) Evaluation by Simulation

The suitability degree determination unit 13 estimates the characteristic of reception of a GNSS satellite signal in a certain segment by simulation. Specifically, a method of estimating a dilution of precision (DOP) value of a visible satellite signal at a reception position in each of the segments using three-dimensional map data including building height information and public GNSS satellite orbit information, and a method of estimating a generation situation of a multipath signal by a structure around a reception position in each of the segments by three-dimensional ray trace simulation are considered. The suitability degree determination unit 13 classifies the class of the GNSS positioning suitability degree of each of the segments on the basis of the result of the simulation over time. Note that the larger the DOP value, the lower the GNSS positioning suitability degree. The higher the intensity of the multipath signal, the lower the GNSS positioning suitability degree.

### (iv) Evaluation by Output Data of GNSS Receiver 22

The suitability degree determination unit 13 classifies the class of each of the segments using, as data of the positioning state output from the GNSS receiver 22, an error ellipse, the frequency of occurrence of a cycle slip, the ratio of the convergence (FIX) solution of the solution of RTK-GNSS positioning calculation in the positioning calculation unit 12, the ratio (ratio value) of residual values of a first solution and a second solution of a least-squares ambiguity decorrelation adjustment (LAMDA) method and the like. The larger the diameter of the error ellipse and the frequency of occurrence of a cycle slip, and the smaller the FIX solution ratio and the ratio value, the lower the GNSS positioning suitability degree of the segment is evaluated.

As described above, the suitability degree determination unit 13 classifies the segments of the environment map production target area into two or more classes based on the GNSS positioning suitability degree. As a result, a segment in which all GNSS positioning solutions are used for production of the environment map and a segment in which some of GNSS positioning solutions are used for production of the environment map are sorted out (distinguished). For example, a threshold for classifying (ranking) the GNSS positioning suitability degree is set in advance for an evaluation value based on any one or more of the above evaluation methods (i) to (iv). The suitability degree determination unit 13 classifies the GNSS positioning suitability degree of each of the segments into a class by comparing the evaluation value with the threshold.

The reception environment in which the class of GNSS positioning suitability degree is the highest is an open sky reception environment in which there is almost no shielding object. The reception environment having the lowest class of the GNSS positioning suitability degree is, for example, a deep urban canyon reception environment in which there is a high-rise building around a road and an open space region in which a satellite signal can be received by a direct wave is significantly restricted, a reception environment near a tunnel entrance, or a reception environment near a place under an elevated portion. The convergence (FIX) solution of the GNSS positioning in the segment having the highest GNSS positioning suitability degree is considered to have a high probability of being a valid solution close to a true value.

### (B) Validity Test of GNSS Positioning Solution

On the basis of the classification result of the class of the GNSS positioning suitability degree of each of the segments of the environment map production target area by the suitability degree determination unit 13 described above, the GNSS positioning solution is determined to be a valid solution for data collected in a segment having a high GNSS positioning suitability degree and is adopted for map production. On the other hand, as for data of a segment having a low GNSS positioning suitability degree, the validity test unit 14 performs a test of the validity of each GNSS positioning solution (whether the GNSS positioning solution is a valid solution close to a true value) by the following procedure, and then adopts only data that satisfies the standard for map production.

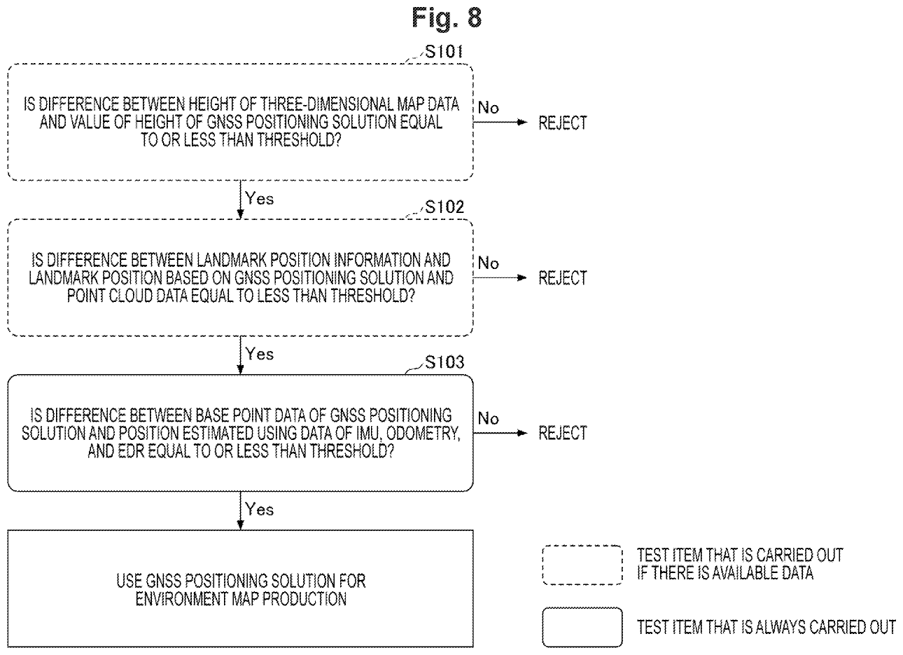

FIG. 8 is a diagram for describing a procedure of the validity test of a GNSS positioning solution. As described above, since an error of a GNSS positioning solution caused by the influence of the reception environment does not have normal whiteness, applying a statistical outlier test method is not necessarily effective. Therefore, the validity test unit 14 performs a test by comparison with a reference value (expected value), and selects some GNSS positioning solutions as valid solutions. Details will be described below.

### (S101) Test Based on Height Value of GNSS Positioning Solution

In a case where three-dimensional map data can be used (in a case where three-dimensional map data is separately prepared in advance), the validity test unit 14, using height (elevation) information of the road surface at the two-dimensional position (latitude, longitude) of a GNSS positioning solution as a true value for a reference of the test, rejects data in which a deviation between a value obtained by correcting the height value of the road surface of the map data in consideration of the position of the height of the GNSS antenna from the road surface of the measurement vehicle and a value of the height (elevation) of the GNSS positioning solution is larger than a threshold (for example, 30 cm).

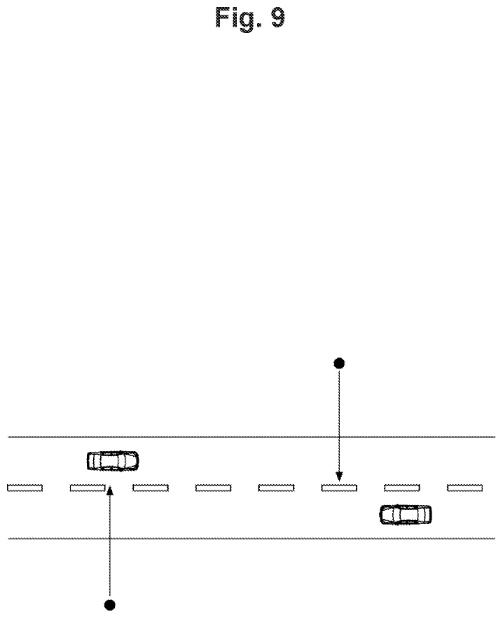

Although a GNSS positioning solution may be rejected in a case where the GNSS positioning solution does not exist on the road since it is highly likely that the GNSS positioning solution is not a valid solution, as illustrated in FIG. 9, a difference between the height of the road surface and the height of the GNSS positioning solution may be evaluated using a value of map data of a road center line closest to the GNSS positioning solution. Furthermore, the offset of the height data of the three-dimensional map data may be corrected by performing comparison with a convergence (FIX) solution of the GNSS positioning solution in a segment having the highest GNSS positioning suitability degree. This is because the convergence (FIX) solution in the segment having the highest GNSS positioning suitability degree is considered to have a high probability of being a valid solution close to a true value.

### (S102) Test Based on Landmark Position Information

In a case where data of a landmark in the vicinity of the road, such as a manhole, a utility pole, a street lamp, a traffic light, or a sign, having highly accurate three-dimensional position information can be used, the validity test unit 14, using the landmark position as a true value for a reference of the test, rejects data in which a deviation between the landmark position calculated from the GNSS positioning solution and point cloud data of the laser scanner 23 and a corresponding position of landmark position information data is larger than a threshold (for example, 30 cm). Furthermore, the offset of the data of the landmark position information may be corrected by performing comparison with the landmark position measurement value based on the point cloud data using the convergence (FIX) solution of the GNSS positioning solution in the segment having the highest GNSS positioning suitability degree.

(S103) Test by Evaluation of Consistency with Data of IMU 24, Odometry 26, And EDR 25

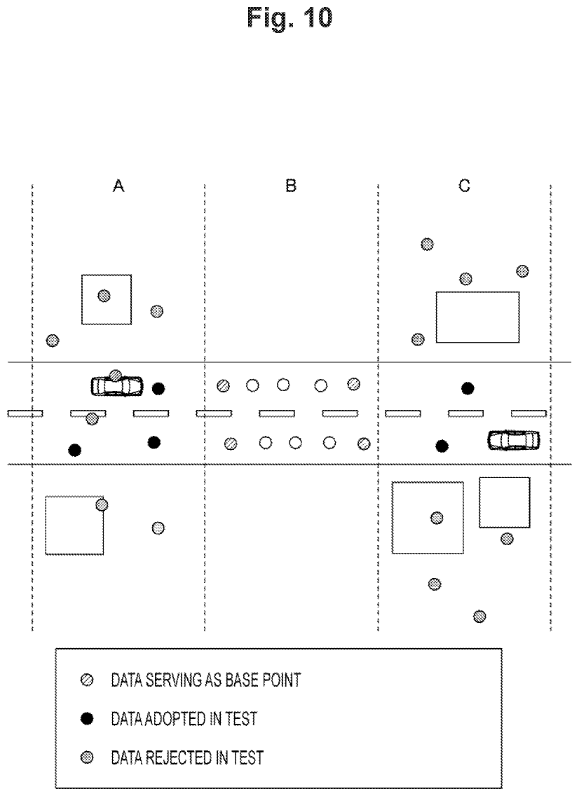

The validity test unit 14 extracts data serving as a base point from GNSS positioning solutions of a data stream, treating data before and after a time zone measured by the same measurement vehicle (ID) (for example, data acquired on the same day) as the same data stream. As for the data serving as a base point, a convergence (FIX) solution by the carrier phase positioning method at a position closest to a segment of a test target is extracted from data that is in a segment of a class of the highest GNSS positioning suitability degree (for example, segment B of FIG. 10) and is close to a segment classified into a class of a test target (of a low GNSS positioning suitability degree) (for example, segment A and segment C in FIG. 10), as a result of (A) GNSS positioning suitability degree determination. The convergence (FIX) solution in the segment having the highest GNSS positioning suitability degree is considered to have a high probability of being a valid solution close to a true value.

Note that, in FIG. 10, two base points are illustrated in each of the segment A part and the segment C part in the segment B. Among these base points, base points included in the lower lane in the drawing are base points for traveling (movement) in the left direction in the drawing, and base points included in the upper lane in the drawing are base points for traveling (movement) in the right direction in the drawing.

The validity test unit 14 determines whether the GNSS positioning solution of a segment of a test target is a valid solution (selects a valid solution from GNSS positioning solutions of the segment of a test target) by evaluating whether there is a contradiction between the GNSS positioning solution of the segment of a test target and a position estimated by integrating a relative displacement amount by the IMU 24, an integrated value of the vehicle speed data by the odometry 26, and a steering angle based on data of the EDR 25 (estimated value of the movement route of the measurement vehicle), which are measured from the coordinate value of data that serves as a base point (whether the degree of a deviation (difference) is equal to or less than a threshold). The validity test unit 14 also evaluates a movement route in a direction opposite to the traveling direction of the vehicle (direction in which the time advances) in a similar procedure (FIG. 10). Alternatively, the position at a base point is obtained by tracing the movement route in the traveling direction or the opposite direction from the GNSS positioning solution of a test target, and the deviation between the obtained position and the positioning solution at the base point is evaluated. Here, in addition to the data of the IMU 24, the odometry 26, and the EDR 25, data of LiDAR Inertial Odometry (LIO) based on measurement data of the laser scanner 23 may be used as data of a relative displacement measurement means used for consistency evaluation. Note that a GNSS positioning solution for which a determination result indicating that the GNSS positioning solution is a valid solution is obtained in either the determination in the traveling direction (direction in which the time advances) of the vehicle or the determination in the opposite direction is finally determined to be a valid solution.

The valid solution of the GNSS positioning solution may be sorted out by executing all the above steps of S101 to S103, or the valid solution of the GNSS positioning solution may be sorted out by executing any one or two steps.

The above is a procedure of sorting out (extracting) a valid solution of the GNSS positioning solution.

The map production unit 15 performs complex positioning calculation in the forward direction (direction in which the time advances) and the reverse direction (direction opposite to the direction in which the time advances) using the valid solution of the GNSS positioning solution sorted out by the suitability degree determination unit 13 and the validity test unit 14 and the data of the IMU 24 and the odometry 26. Here, data of LiDAR inertial odometry (LIO) may be used as a relative positioning means. The complex positioning calculation is performed by tight coupling using an extended Kalman filter (EKF), an unscented Kalman filter (UKF), a particle filter, or the like or loose coupling.

The class value of the GNSS positioning suitability degree of a segment to which the GNSS positioning solution belongs is used for determining contribution (weighting, gain) of the GNSS positioning solution in the complex positioning calculation. For example, the map production unit 15 performs complex positioning calculation processing in which weighting of the GNSS positioning solution is increased (reliability of the GNSS positioning solution evaluated to be high and contribution is increased) in a segment having a high GNSS positioning suitability degree. Furthermore, as for a time epoch in which there is no valid solution of the GNSS positioning solution that has passed the test in a segment having a low GNSS positioning suitability degree, the map production unit 15 performs complex positioning calculation by a valid solution of a GNSS positioning solution of a time epoch in the vicinity of the same data stream and dead reckoning (DR) in the forward direction and the reverse direction using data of the IMU and the odometry (and LIO).

The map production unit 15 creates an environment map (creates map data of the environment map) using the complex positioning solution obtained by the above procedure and the point cloud data obtained by the laser scanner 23. In the process of creating the point cloud map data, distortion and the like are appropriately corrected for map data obtained by removing noise data of other vehicles, pedestrians, and the like and extracting only data of a permanent structure such as a building.

In the present embodiment, the distortion of the created point cloud map data is reduced by sorting out a valid solution from GNSS positioning solutions, and the correction work can be reduced. The map production unit 15 may perform correction by loop closure processing on the map extracted from the point cloud data. The map production unit 15 may also perform calibration including absolute position accuracy on the environment map extracted from the point cloud data using existing highly accurate two-dimensional map data. The final product of the environment map may be point cloud map data or a vector map obtained by extracting feature data from the point cloud map and reducing the data capacity.

It is possible to improve the work efficiency of environment map data production and improve the quality of the environment map data by rejecting data having low validity of a GNSS positioning solution according to the above procedure.

### (3) Map Data Distribution Process

The map data distribution unit 16 of the map production/distribution server 10 distributes the environment map data produced in the map production process together with the data regarding GNSS positioning suitability degrees obtained in the map production process to the autonomous traveling vehicle that includes the self-position estimation device 30 by a communication means such as mobile communication, wireless LAN, or V2X. As the environment map data, data of areas in which an autonomous traveling vehicle is required may be collectively downloaded. Alternatively, in order to reduce the communication band, data of an area in which the vehicle is scheduled to travel on the basis of the current position and the traveling direction of the traveling vehicle may be distributed on demand each time.

The autonomous traveling vehicle performs self-position estimation by the self-position estimation unit 34 of the self-position estimation device 30 using the received environment map and the point cloud data obtained by the laser scanner.

The data regarding GNSS positioning suitability degrees is used for the following purposes in the autonomous traveling vehicle (self-position estimation device 30).
(i) This is used for determining a search range in a case where the autonomous traveling vehicle searches an environment map from an approximate position by the self-position estimation unit 34 of the self-position estimation device 30. The self-position estimation unit 34 sets the search range to be narrow in a segment having a high GNSS positioning suitability degree because the accuracy of the approximate position output from the GNSS receiver 32 of the self-position estimation device 30 is expected to be high, and sets the search range of the environment map to be wide in a segment having a low GNSS positioning suitability degree. As a result, it is possible to reduce processing of the self-position estimation unit 34 and to reduce the risk of occurrence of an error in matching processing of the environment map due to insufficient accuracy of the approximate position.
(ii) In a case where the complex positioning means such as the GNSS/IMU is included in the self-position estimation device 30 of the autonomous traveling vehicle as a backup self-position estimation means in preparation for a failure of the laser scanner 33, the traveling vehicle (self-position estimation device 30) can dynamically change the weighting of the positioning means on the basis of the GNSS positioning suitability degree. The self-position estimation unit 34 increases the weighting of a GNSS positioning solution in coupling processing in a segment having a high GNSS positioning suitability degree. In a segment having a very high GNSS positioning suitability degree (for example, top N-th segments (N is set in advance)), the accumulated error of the IMU can be corrected by the GNSS positioning solution. Furthermore, in a segment having a very low GNSS positioning suitability degree (for example, lower M-th segments (M is set in advance)), it is possible to proactively separate the GNSS positioning solution from complex positioning calculation and shift to DR operation.

In addition, the GNSS positioning suitability degree can be used as alert information indicating the reliability of the self-position estimation result in a case where the self-position estimation device 30 of the autonomous traveling vehicle outputs the self-position estimation result (coordinate value) to the control device.

### (4) Map Data Update Process

The produced environment map is distributed in (3) map data distribution process and used by self-position estimation of the autonomous traveling vehicle, the measurement vehicle (data collection device 20) continuously collects data of a target area regularly or irregularly, and the map production/distribution server 10 updates the environment map data. In the data collection in the map data update process, since the self-position estimation result by the environment map is used, the position estimation accuracy of the measurement vehicle is improved as compared with data collection at the time of initial production of the environment map, and it is expected that valid point cloud data can be collected. In the update work of the environment map data, a difference between new map data produced in (2) map production process and the original map data is extracted from the measurement data, and the environment map data is updated. Since the situation (physical position) of a shielding object that affects the GNSS positioning accuracy does not change frequently over time, the GNSS positioning suitability degree can be basically continuously used as a semi-static index, but in a case where the situation of structures around the road changes, data collected before update in each segment in the vicinity is reset, and the class classification of the GNSS positioning suitability degree is updated.

One of roles of the map data update process other than update of the environment map data is to increase the number of pieces of data of a valid solution of the GNSS positioning solution in a segment having a low GNSS positioning suitability degree, and to improve the quality of the environment map. Furthermore, as a cumulative amount of collected data increases, the granularity of segment division can be improved (regions of segments can be narrowed). Furthermore, in a segment having a high GNSS positioning suitability degree, quality check of the environment map can be performed by comparing the positioning result based on the environment map with the GNSS positioning solution. In this way, by repeating the map data update process, not only freshness of the environment map data is maintained, but also quality can be continuously and gradually improved.

The information of GNSS positioning suitability degrees may be displayed as a heat map on a map, for example, so that an auxiliary driver of the autonomous traveling vehicle or an operator of remote monitoring can visually recognize the information. Accordingly, it is possible to give an opportunity to call the operator's attention or to perform switching to a manual driving operation. Furthermore, an application programming interface (API) or the like may notify an operation management system of the information of GNSS positioning suitability degrees.

In order to improve the accuracy of the class classification of the GNSS positioning suitability degrees, data may be collected in a crowdsourcing manner using a general vehicle other than a commercial vehicle as a measurement vehicle. In this case, only the GNSS receiver 22, the data saving unit 28, and the communication unit 29 may be included in the data collection device 20 instead of the configuration of FIG. 2, and a code positioning solution by the GNSS receiver 22 of which the cost is low may be collected.

The present embodiment can be applied not only to autonomous traveling but also to a driving assistance system such as advanced driver-assistance systems (ADAS) using an environment map.

As described above, according to the present embodiment, a sufficient number of pieces of data are collected in different time zones in an area for which an environment map is produced, data is sorted out by rejecting data of a GNSS positioning solution having low validity by statistical processing based on a positioning result, thereby enabling improving work efficiency of producing the environment map and improving the quality of the environment map.

Furthermore, information regarding an expected value of GNSS positioning accuracy is distributed together with environment map data, thereby enabling improving the reliability of self-position estimation operation of automatic traveling.

Note that, in the present embodiment, the map production/distribution server 10 is an example of an environment map production device. The suitability degree determination unit 13 is an example of a calculation unit and a sort out unit. The validity test unit 14 is an example of a selection unit.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Map production/distribution server
11 Data reception unit
12 Positioning calculation unit
13 Suitability degree determination unit
14 Validity test unit
15 Map production unit
16 Map data distribution unit
17 Data storage unit
20 Data collection device
21 GNSS antenna
22 GNSS receiver
23 Laser scanner
24 IMU
25 EDR
26 Odometry
27 Clock unit
28 Data saving unit
29 Communication unit
30 Self-position estimation device
31 GNSS antenna
32 GNSS receiver
33 Laser scanner
34 Self-position estimation unit
35 Data output unit
36 Data saving unit
37 Communication unit
100 Drive device
101 Recording medium
102 Auxiliary storage device
103 Memory device
104 Processor
105 Interface device
B Bus

1. An environment map production device comprising a processor configured to execute operations comprising:
calculating an evaluation value of validity of a positioning solution based on data obtained by measurement by a vehicle traveling in an area in a plurality of timeframes using a global navigation satellite system (“GNSS”) for each of a plurality of segments that divides the area; and
generating, on a basis of the evaluation value of the validity of the positioning solution, an environment map, by classifying the positioning solution into either one of the positioning solution used for production of the environment map or the positioning solution not used for production of the environment map.

2. The environment map production device according to claim 1, wherein the calculating further comprises calculating an evaluation value of a distribution state of the positioning solution as the evaluation value of the validity of the positioning solution.

3. The environment map production device according to claim 2, wherein the classifying further comprising selecting a first segment in the area and a second segment in the area, the first segment comprises positioning solutions collected for the first segment are used to generate the environment map, and the second segment comprises a part of positioning solutions collected for the second segment are used to generate the environment map.

4. The environment map production device according to claim 3, the processor further configured to execute operations comprising:
selecting the part of positioning solutions among the positioning solutions collected for the second segment based on a height of a road surface at a position in a corresponding positioning solution and a reference value.

5. The environment map production device according to claim 3, the processor further configured to execute operations comprising:
selecting the part of positioning solutions among the positioning solutions collected for the second segment based on a position of a landmark obtained according to a corresponding positioning solution and a true value of the position of the landmark.

6. The environment map production device according to claim 3, the processor further configured to execute operations comprising
selecting a positioning solution in which a deviation from an estimated value of a movement route of the vehicle from the positioning solution collected for the first segment is within a threshold among the positioning solutions collected for the second segment.

7. An environment map production method executed by a computer, comprising:
calculating an evaluation value of validity of a positioning solution based on data obtained by measurement by a vehicle traveling in an area in a plurality of timeframes using a global navigation satellite system (“GNSS”) for each of a plurality of segments that divides the area; and
generating, on a basis of the evaluation value of the validity of the positioning solution, an environment map, by classifying the positioning solution into either one of the positioning solution used for production of the environment map or the positioning solution not used for production of the environment map.

8. A computer-readable non-transitory recording medium storing a computer-executable program instructions that when executed by a processor cause a computer to execute operations comprising:
calculating an evaluation value of validity of a positioning solution based on data obtained by measurement by a vehicle traveling in an area in a plurality of timeframes using a global navigation satellite system (“GNSS”) for each of a plurality of segments that divides the area; and
generating, on a basis of the evaluation value of the validity of the positioning solution, an environment map, by classifying the positioning solution into either one of the positioning solution used for production of the environment map or the positioning solution not used for production of the environment map.

9. The environment map production device according to claim 3, wherein the measurement comprises a vehicle position as measured by a navigation sensor of a mobile mapping system onboard the vehicle and a spatial information of a surrounding area of the vehicle as measured by an attribute sensor of the mobile mapping system onboard the vehicle.

10. The environment map production device according to claim 3, wherein the plurality of timeframes comprises a first timeframe within a predetermined period of time and a second timeframe with the predetermined period of time, the first timeframe is distinct from the second timeframe, and the first timeframe represents a time zone of a day.

11. The environment map production device according to claim 3, wherein the evaluation value of validity of the positioning solution is based on at least one of:
a contradiction between a GNSS positioning solution of a segment of a test target and a position estimated by integrating a relative displacement amount as measured by an inertial sensor,
an integrated value of vehicle speed data as measured by an odometry sensor, and
a steering angle based on event data as recorded by an event data recorder as an estimated value of a movement route of the vehicle.

12. The environment map production device according to claim 5, wherein the position of the landmark corresponds to a three-dimensional location information with accuracy that is higher than a predetermined threshold.
